(19) United States
(12) Patent Application Publication
(10) Pub. No.: US 2007/0220008 A1
(43) Pub. Date: Sep. 20, 2007

(54) System and method for single client remote access

(75) Inventors: Amir Mizhar, Modiin (IL); Amiad Nesher Grandt, New York, NY (US); Simon Grunfeld, New York, NY (US)

Correspondence Address: OSTROLENK FABER GERB & SOFFEN, 1180 AVENUE OF THE AMERICAS, NEW YORK, NY, 100368403, US

(73) Assignee: eTouchWare Inc.

(21) Appl. No.: 11/375,479

(22) Filed: Mar. 14, 2006

(51) Int. Cl. G06F 17/30

(52) U.S. Cl. 707/10

(57) ABSTRACT

The invention comprises a system and method for facilitating a transfer of a data file over a communication network. In one embodiment, a first workstation having a data file stored thereon identifies a receiver of the data file, and transmits to the receiver an invitation to receive the data file. The receiver, a second workstation, uses the invitation to communicate to a web server an address for receiving the data file. The information processor securely receives packets of the data file and modifies header information in the packets before forwarding the packets of the data file to the second workstation. In an alternative embodiment, the receiver workstation invites a sender workstation to transmit a file.

### FIELD OF THE INVENTION

The present invention relates generally to communication, and, more particularly, to facilitating the transfer of data over a communication network.

### BACKGROUND OF THE INVENTION

The number of people using computer technology, and, in particular, personal computers, continues to grow. As the cost of computers and computer components, e.g., memory and hard drives, continues to fall, people use increasingly complex software applications that produce files of significant size. For example, presentation software applications, such as MICROSOFT POWERPOINT, graphic editors, such as ADOBE PHOTOSHOP, and database and spreadsheet applications enable users to create data files (e.g., presentation files, multi-media files, such as image, audio and moving image files, database and spreadsheets) that may be tens or hundreds of millions of bytes in size.

Despite a relative increase in the sizes of data files, users of computing devices have a need to share data files quickly and as easily as possible. A common method of transferring data files is by e-mail, typically by attaching one or more files to an e-mail message. This typically involves a user selecting a data file on his computing device to attach to an e-mail message, and then transmitting the message with the attachment to the recipient's e-mail server. When the recipient receives his e-mail, the message and attachment are transferred from the e-mail server to the recipient's computing device. Unfortunately, transmitting large-sized data files by e-mail is inefficient and impractical. For example, transmitting a large-sized file by e-mail is very slow and not very secure. Further, a data file may reside on the recipient's e-mail server for an extended period of time (until the recipient receives his e-mail). Further, the e-mailed data file may never reach its intended recipient. Many network e-mail servers have restrictions that prevent data transmissions that are above a certain size, for example, five megabytes. Such servers essentially block such transmissions, thereby preventing the sender from transmitting a data file. Also, many e-mail providers and/or recipients employ services, such as anti-spam and anti-virus services, that prevent e-mail messages which do not meet certain criteria from reaching an intended recipient. Often, an e-mail filtering service does not alert the sender that an e-mail message (and attachment) was blocked and not delivered to a recipient. The sender, in this case, is not even aware that a problem with the transmission occurred.

Other options are available for transmitting large-sized files. One option is known in the art as a remote storage solution. This option allows a user to store data on a remote server, where it can be accessed by a remote user using, for example, a known file transfer mechanism such as the file transfer protocol (“FTP”) and the hypertext transfer protocol (“HTTP”). Some providers of remote storage facilities give users who store data thereon an option to send a hyperlink to a recipient, for example, via an e-mail or instant message, such that the recipient can connect to the remote storage facility and receive the data file simply by selecting the hyperlink. One shortcoming of remote storage solutions is a need for a third-party storage device, such as a server, which may result in compromised security since parties under the control of the storage device provider have access to the device. Prior art examples of this solution include GROOVE.NET, FOLDERSHARE.COM, GLOBALSCAPE.COM and PANDO.COM.

In addition to commercially available web sites providing remote storage solutions, another solution for transmitting large sized files is to configure a computer to operate as a “FTP server.” In this example, a computer is configured with software to enable remote access to directories and/or data files on the FTP server. Any other computing device configured with FTP “client” software can access the directory/file(s) when a user is provided with authorization.

Referring now to the drawings, in which like reference numerals refer to like elements, FIG. 1 illustrates a typical prior art arrangement in which a first client device 102 connects to an FTP server 104, typically by using FTP client software and by providing a valid user name and password in order to upload a data file 106 to the FTP server 104. A second client device 102 connects to the FTP server by using FTP client software, e.g., by providing a user name and password, and then downloads the file 106 from the FTP server 104. Examples of prior art FTP server and client software include WS_FTP, FTPSHELL, WINFTP, SERV-U FTP, and BULLETPROOF.

Yet another alternative for transmitting data files is known in the art as a remote control software application. A remote control application enables one computing device, known in the art as a “guest,” to access remotely another computing device, known in the art as a “host.” Remote control applications enable a user to access and control another computing device and perform many if not all of the actions of the host device remotely. In addition to a remote control capability, many remote control applications provide a file transfer mechanism such that data files that are available on the host can be transferred to the guest. A shortcoming of remote control application is that the remote control application, or some respective element thereof, must be installed on both the host and the guest devices. Moreover, remote control applications can require complex configuring, especially in connection with network security devices such as firewalls, proxy servers or the like. Examples of remote access software applications include VNC, RADMIN, PCANYWHERE, GOTO MY PC and BLUEROAM.

Although techniques are known for transmitting and receiving data files, it is believed by the inventors that prior art solutions remain problematic. For example, transmitting data files by e-mail can be unreliable, insecure, slow or impossible (depending upon the file's size). Transmitting files using remote storage facilities requires a third party server to store the file prior to the receiving party accessing the file. FTP server and client software requires additional installing and configuring of computing devices. Further, remote control access software applications require hosts and guests to install and configure software applications on their respective computing devices

### SUMMARY OF THE INVENTION

The present invention addresses a need in the industry for convenient, secure and efficient transfer of data files between respective computing devices.

The invention comprises a system and method for facilitating a transfer of a data file over a communication network. In one embodiment, a first workstation (a sender) having a data file stored thereon identifies a second workstation (a receiver) for the data file, and transmits to the second workstation an invitation to receive the data file. The invitation includes at least an identifier or the IP address of the first workstation. The second workstation uses the invitation, which inherently includes the IP address of the second workstation, to communicate via the hypertext transfer protocol (“HTTP”) to a web server. In a preferred embodiment, the user of the second workstation submits a user name and password to the web server to establish that the user is authorized to receive the data file. The HTTP session between the second workstation and the web server is preferably maintained until the second workstation has fully received the data file.

Prior to transmitting the data file, the first workstation preferably maintains an active connection to a communication network, such as the internet, and operates software to recognize whenever the web server attempts to communicate with the first workstation. In other words, the first workstation operates software that “listens,” for example, on a predefined port for the web server. The web server contacts the first workstation, the first workstation replies and an active data communication session is maintained between the first workstation and the web server while the HTTP session is active between the second workstation and the web server.

While the web server has an active communication session with the first workstation and the second workstation, the software operating on the first workstation preferably compresses the data file, and thereafter transmits encrypted packets of the data file to the web server. In one embodiment, the web server and the second workstation maintain a secure HTTP (“HTTPS”) session, thereby effecting the security (e.g., encryption) of the files. The web server subsequently transmits the data file, preferably via HTTP, to the second workstation.

Thus, the present invention preferably enables a transfer of files, regardless of size, without the need to store the complete files on a remote storage location. Further, the present invention enables the transfer after at least one of the sending or the receiving workstation installs a software “client” program. The transfer is effected by a third tier server (e.g., the information processor) that manages the transfer. Unlike the prior art, the web server does not store the complete file and, thereafter, wait for a remote user to download the file therefrom.

In an alternative embodiment of the present invention, only the receiving workstation has the client program installed thereon. In this embodiment, the receiving workstation uses the client program to identify a data path (or data folder) to receive a data file, and an invitation to receive a data file is transmitted from the receiving workstation to a sending workstation. The invitation is used by the sending workstation to establish a session, preferably HTTP, with the web server. A web form is preferably provided by the web server to the sending workstation and used to identify a data file, such as by navigating data folders and files, that is available to the sending workstation. The sending workstation uploads packets of the data file to the web server, and the web server forwards the packets to the receiving workstation.

In a preferred embodiment of the present invention, the packets of the data file that are transmitted from the sending workstation to the receiving workstation are not stored on the web server. Instead, the device running as a web server modifies data packets by changing header information that identifies the socket of the receiving workstation (e.g., including the IP address and port of the receiving workstation). By altering the packets' header information, the web server operates as a sort of pass-through device and does not store the packets for any considerable amount of time.

The present invention is operable such that a data file transfer can occur when the sending workstation, the receiving workstation, or both workstations have the client software installed thereon.

Other features of the present invention are provided. For example, a database may be provided on web server that stores an identifier (e.g., an index value) representing the first workstation and further stores a corresponding IP address. The identifier is used by the web server to make reference to the first workstation. In case the IP of the first workstation changes, such as resulting from a dynamically assigned IP address by a service provider, the database is updated to reflect the new IP address. The invitation transmitted to the receiving (second) workstation preferably includes the identifier, and the identifier is preferably transmitted to the web server by the second workstation, which represents the first workstation. The web server uses the identifier to communicate with the first workstation and instruct it to transmit the data file.

In a preferred embodiment, various messages are transmitted to the workstations to inform the users thereof of certain conditions. For example, in case the first workstation is not maintaining an active connection to the communication network (i.e., is off-line), or is otherwise not communicating with the web server, then the web server alerts the second workstation that the transfer will not take place at that time. Alternatively, in case the user of the second workstation submits a password that is rejected by the first workstation, a message is transmitted to the user of the second workstation that an incorrect password was submitted. The messages may be formatted in various ways, such as web pages, instant messages, or e-mail messages.

Other features and advantages of the present invention will become apparent from the following description of the invention, which refers to the accompanying drawings.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 illustrates a typical prior art arrangement in which a FTP client device connects to a FTP server;

FIG. 2 shows an example hardware arrangement in a preferred embodiment of the present invention;

FIG. 3 illustrates the functional elements of workstation and/or information processor;

FIG. 4 is a portion of example display screen that illustrates pop-up menu that enables a user to select a particular data file to transmit to a receiving workstation;

FIG. 5 is an example display screen that enables a user of a sending workstation to create a hyperlink to be used in a notification to a receiving workstation;

FIG. 6 illustrates an example display screen for e-mailing a notification to a receiving workstation;

FIG. 7 is an example display screen that illustrates an example invitation received by a receiving workstation;

FIG. 8 is an example display screen that preferably includes a progress bar indicating the completion percentage of a download process;

FIG. 9 is an example display screen that is provided upon successful completion of a file transfer between a sending workstation and a receiving workstation;

FIG. 10 illustrates a pop-up menu that enables a user of a receiving workstation to request that one or more data files be stored in a particular data folder (or directory) on the receiving workstation;

FIG. 11 illustrates an example folder sharing selection display screen that is provided for a user of a receiving workstation;

FIG. 12 is an example display screen that enables a user to create a hyperlink to be used in a notification (referred to herein as an invitation);

FIG. 13 illustrates an example display screen that preferably appears when a user selects a control to e-mail the notification;

FIG. 14 is an example display screen that illustrates an example invitation received by a sending workstation;

FIG. 15 is an example display screen that preferably includes a progress bar indicating the completion percentage of an upload process; and

FIG. 16 is an example display screen that is provided upon successful completion of a file upload between a sending workstation and a receiving workstation.

### DETAILED DESCRIPTION OF THE PREFERRED EMBODIMENTS

The present invention includes a topology for transferring data files, including large-sized files, conveniently and without the need for a remote storage location. Further, the invention enables a transfer by installing additional software on one (or both) of the sender's computing device and the recipient's computing device.

In an embodiment, a transfer of a data file is managed, in part, by a third tier server, preferably a computing device configured to operate as a HTTP server, as known in the art. This server, referred to generally herein as a “web server,” preferably executes a so-called “low level” script that operates to manage the transfer of the data file from the sender to receiver. The script enables the web server to direct the process of transferring the file from the sender to the receiver by receiving from the sender packets of the file, and forwarding the packets to the receiver. By directing the transfer between two devices, a secure and fast transfer of data files between two computing devices is provided. In a preferred embodiment, either the receiving computing device or the sending device can operate merely with standard internet web browsing software.

As used herein, the term, “module” refers, generally, to one or more discrete components that contribute to the effectiveness of the present invention. Modules can operate or, alternatively, depend upon one or more other modules in order to function.

Also as used herein, the term “upload” refers, generally, to transmitting a data file from a first computing device to a second computing device. The computing device that sends the data file uploads the file. The term, “download” refers, generally, herein to receiving a data file transmitted from a first computing device to a second computing device. The computing device that receives the data file downloads the file thereto.

Also as used herein, a “sending workstation” refers, generally, to a computing device that is transmitting, has transmitted or will transmit a data file in accordance with the teachings herein. A “receiving workstation” refers, generally, to a computing device that is receiving, has received, or will receive a data file in accordance with the teachings herein. As will become clear to one skilled in the art, a sending workstation and a receiving workstation may refer to the same computing device in different contexts. For example, a single computing device operates as a sending workstation when that device transmits a data file, and also operates as a receiving workstation when that device receives a data file.

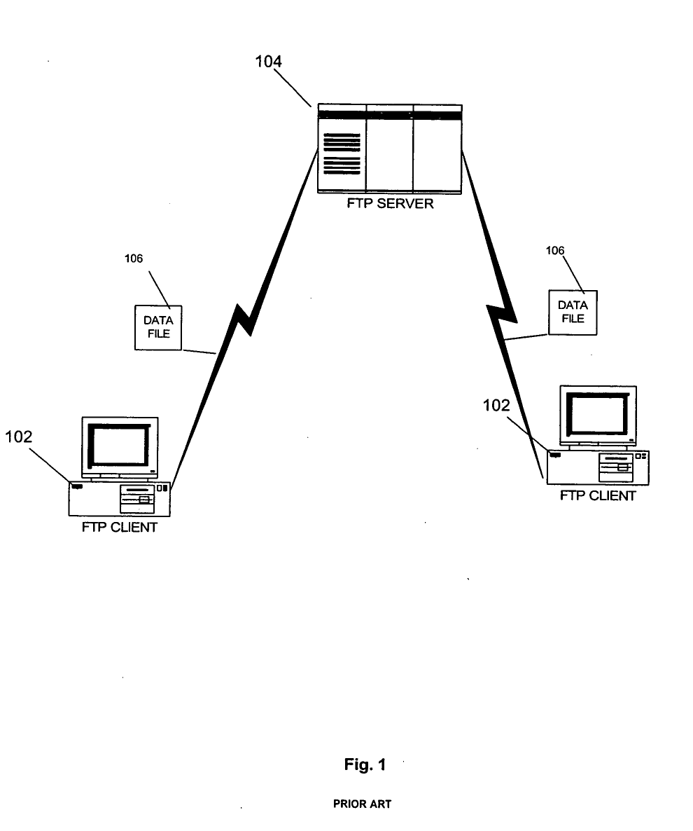

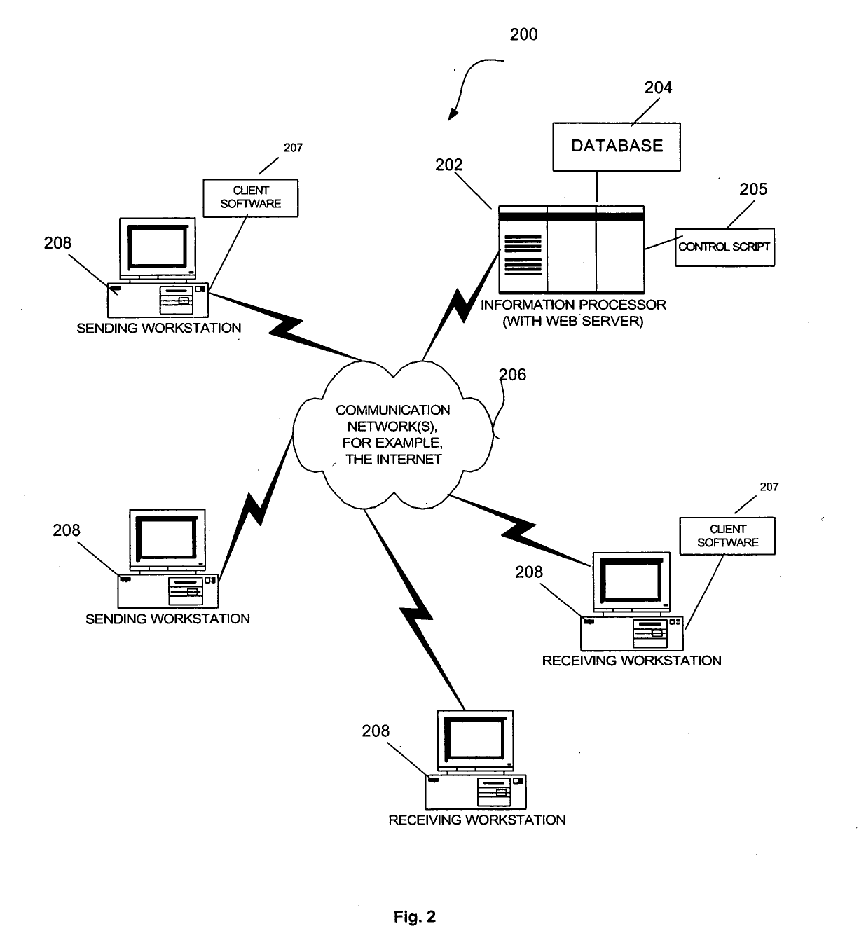

FIG. 2 shows an example hardware arrangement in an embodiment of the present invention and referred to generally as system 200. In the embodiment shown in FIG. 1, system 200 comprises at least one information processor 202 which configured to operate as an internet web server and that is operable to access and update a database 204. Further, information processor 202 preferably is operable to execute script 205 in order to direct communications in accordance with the present invention.

Information processor 202 preferably accesses communication network 206 and communicates with workstations 208, such that workstations 208 are operable to transmit and receive data files 106 there-between. Preferably, workstations 208 and information processor 202 communicate via the known communications protocol, Transmission Control Protocol/internet Protocol (“TCP/IP”). Also as illustrated in FIG. 2, some of the workstations 208 are identified as sending workstations 208 and some are identified as receiving workstations 208. As noted above, in accordance with the present invention, any workstation 208 can operate as a receiving workstation or a sending workstation, depending upon a particular context. Therefore, the workstations 208 shown in FIG. 2 are illustrated to represent a various contexts, i.e., either as receiving workstations 208 or sending workstations 208. Furthermore, some of the workstations 208 are illustrated to include client software 207. As described in greater detail below, in any given transmission client software 207 is preferably installed on at least one of the sending workstation 208 and the receiving workstation 208. Thus, unlike the prior art, it is not necessary that both a sending workstation 208 and a receiving workstation 208 have client software 207 installed.

In accordance with the teachings herein, information processor 202 does not store a copy of a data file 106, but operates to forward packets received from a sending workstation 208 to a receiving workstation 208. In this way, content can be transmitted to and from devices 208 without the need for central storage. Further, as described in greater detail below, a receiving workstation 208 is operable to receive data file 106 from a sending workstation 208 without a need for special “client” software 207, and/or vice-versa.

In an alternative embodiment, described below, at least one of the workstations 208 can operate as a web server, thereby eliminating a requirement for information processor 202 to operate as a third tier server. As described below, one of the workstations can be configured, for example, via client software 207, to operate as a web server and, accordingly, perform many if not all of the functions described herein with regard to information processor 202. Therefore, although many of the examples and descriptions of the present invention herein include information processor 202 operating as a web server, the invention is not so limited. Either workstation 208 (e.g., the sending workstation 208 or receiving workstation 208) can operate as web server.

Information processors 202 and workstations 208 are any devices that are capable of sending and receiving data across communication network 206, e.g., mainframe computers, mini computers, personal computers, laptop computers, a personal digital assistants (PDA) and internet access devices such as Web TV. In addition, information processors 202 and workstations 208 are preferably equipped with a web browser, such as MICROSOFT INTERNET EXPLORER, NETSCAPE NAVIGATOR, MOZILLA FIRREFOX or the like. Thus, as envisioned herein, information processor 202 and/or workstations 206 are devices that can communicate over a network and can be operated anywhere, including, for example, moving vehicles.

The nature of the present invention is such that one skilled in the art of writing computer executable code (i.e., software) can implement the described functions using one or more of a combination of popular computer programming languages and developing environments including, but not limited to C, C++, Visual Basic, JAVA, PHP, HTML, XML, ACTIVE SERVER PAGES, JAVA servlets, MICROSOFT.NET, C#, ASP.NET, and a plurality of various development applications.

For example, data may be configured in a MICROSOFT EXCEL spreadsheet file, as a comma delimited ASCII text file, as a MICROSOFT SQL SERVER compatible table file (e.g., MS-ACCESS table), or the like. In another embodiment, data may be formatted as an image file (e.g., TIFF, JPG, BMP, GIF, or the like). In yet another embodiment, data may be stored in an ADOBE ACROBAT PDF file. Preferably, one or more data formatting and/or normalization routines are provided that manage data received from one or a plurality of sources. In another example, data are received that are provided in a particular format (e.g., MICROSOFT EXCEL), and programming routines are executed that convert the data to another formatted (e.g., ASCII comma-delimited text).

It is contemplated herein that any suitable operating system can be used on workstations 208 and information processor 202, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC or any other suitable operating system. Of course, one skilled in the art will recognize that other software applications are available in accordance with the teachings herein, including, for example, via JAVA, JAVA Script, Action Script, Swish, or the like.

Moreover, a plurality of data file types is envisioned herein. For example, the present invention preferably supports various suitable multi-media file types, including (but not limited to) JPEG, BMP, GIF, TIFF, MPEG, AVI, SWF, RAW or the like (as known to those skilled in the art).

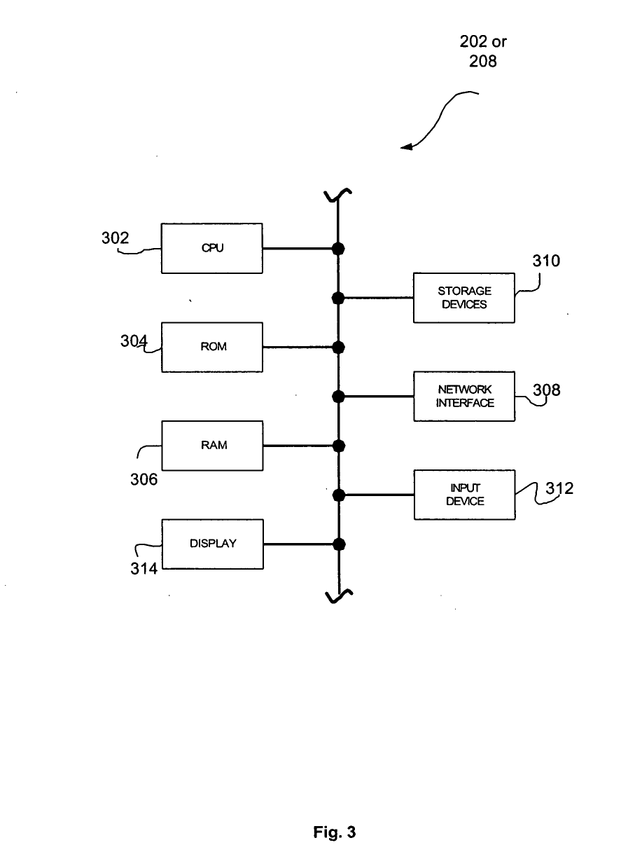

FIG. 3 illustrates the functional elements of workstation 208 and/or information processor 202 and that include one or more central processing units (CPU) 302 used to execute software code and control the operation of workstation 208 or information processor 202, read-only memory (ROM) 304, random access memory (RAM) 306, one or more network interfaces 308 to transmit and receive data to and from other computing devices across a communication network, storage devices 312 such as a hard disk drive, floppy disk drive, tape drive, CD ROM or DVD for storing program code, databases and application data, one or more input devices 312 such as a keyboard, mouse, track ball, magnetic card reading device, bar code reading device, microphone or the like, and a display 314.

The various components of information processor 202 and/or workstation 208 need not be physically contained within the same chassis or even located in a single location. For example, storage device 310 may be located at a site which is remote from the remaining elements of information processor 202 or workstation 208, and may even be connected to CPU 302 across communication network 206 via network interface 308. Information processor 202 preferably includes a memory equipped with sufficient storage to provide the necessary databases, forums, and other community services as well as acting as a web server for communicating hypertext markup language (HTML), FLASH, Action Script, Java, Active Server Pages, Active-X control programs on workstations 208. Information processors 202 are arranged with components, for example, those shown in FIG. 3, suitable for the expected operating environment of information processor 202. The CPU(s) 302, network interface(s) 308 and memory and storage devices are selected to ensure that capacities are arranged to accommodate expected demand.

In accordance with a preferred embodiment, a sending workstation 208 issues a notification, referred to, generally, herein as an “invitation” to a receiving workstation 208 via some form of communication, for example, e-mail or instant messaging. The invitation preferably includes a hyperlink to information processor 202, encoded information about a data file that is to be transmitted to the receiving workstation 208, and an identifier of the sending workstation 208. In one embodiment, information processor 202 maintains a database 204 that stores identifiers of workstations 208 and corresponding IP addresses. In case an IP address of a workstation 208 changes, for example, due to the IP address being dynamically assigned by a service provider, the database 204 is updated to reflect the new address.

Once the invitation is received, the user of the receiving workstation 208 preferably selects the hyperlink contained in the invitation, and the information contained in the invitation is transmitted to information processor 202. Information processor 202 preferably executes script 205 and provides a web form for the user of receiving workstation 208. The user of the receiving workstation 208 preferably submits a user name and password and maintains an active HTTP session with information processor 202. Information processor preferably uses the information received in the invitation to request communication with the sending workstation 208. When the sending workstation 208 replies to the request by information processor 208 the user name and password submitted by the user of the receiving workstation 208 is preferably verified. If the user of the receiving workstation 208 is authorized, the sending workstation 208 compresses, encrypts and transmits the data file 106 in packets to information processor 202. Once the information processor 202 receives the packets, the information processor preferably modifies the packets and changes header information in the packets to identify the receiving workstation 208 as the proper recipient. Thereafter, the packets are transmitted (i.e., forwarded) to the receiving workstation 208 over the active HTTP session between information processor 202 and the receiving workstation 208.

Thus, in accordance with a preferred embodiment, the particular workstation 208 that operates as a sending device (i.e., the device that sends a data file to a receiving workstation 208 via information processor 202) preferably has software installed thereon that enables the transmission of the data file 106. In contrast with the prior art, the workstation 208 that is operable as a receiving device preferably has only standard internet browser software installed and operating thereon. In other words, the receiving workstation 208 preferably uses only a TCP/IP connection in order to receive the data file. The sending workstation 108 operates to compress, encrypt and transfer the data file. In a preferred embodiment, the compression occurs using known methods, such as PKZIP, and the encryption also occurs using known methods, such as transmitting data over a secure HTTP (“HTTPS”) session.

Thus, information processor 102 preferably operates as a web server and further includes software, preferably in the form of script 205. Script 205 is preferably developed in a server side scripting language, such as “ASP.NET” or “PHP.” Script 205 operates to alert information processor 102 that a user of receiving sending workstation 208 desires to receive a data file 106 identified in an invitation from a sending workstation 208. Alternatively, and as described below, script 205 operates to alert information processor that a sending workstation 208 desires to transmit a data file 106 to a receiving workstation 208. When information processor 202 receives packets of a data file 106 from a sending workstation 208, processor 202 preferably changes the header information in the packets in to forward the packets to the receiving workstation 208.

In one embodiment of the present invention, a user of a sending workstation 208 preferably runs a software application that executes instructions on the sending workstation 208 to enable the user to transmit a data file in accordance with the teachings herein. For example, when the user of the sending workstation 208 desires to transmit a data file to a receiving workstation 208, he selects a graphical icon that causes software instructions to execute and to remain resident in memory. For example, on a workstation 208 operating the MICROSOFT WINDOWS operating system, a graphical icon appears in the WINDOWS SYSTEM TRAY that indicates the software is active in memory. Once active, the user of the sending workstation 208 can identify and/or select any file(s) the user to which the user has access in order to transfer the file(s) to a receiving workstation 208. Once selected, an invitation (as described above) is formatted and available to be sent to a receiving workstation 208 via one of various communication protocols, such as Instant Messaging or e-mail. As noted above, the invitation preferably comprises a hyperlink that, when selected by the receiving workstation 208, initiates a communication session with information processor 202 and alerts information processor 202 of the sending workstation 208. Information processor 202 preferably communicates with the sending workstation 208 using the software operating on the sending workstation 208, and the sending workstation 208 sends instructions, such as encrypted POST method values, as known in the art, to enable the sending. In short, the encrypted POST method values contain information enabling the sending workstation 208 to transmit the data file(s) to information processor 202. For example, the information may include: file name(s) and path(s) of the file(s) to be transmitted, the sending workstation name and/or IP address; the communication port number of the sending workstation 208, an amount of time defined for enabling the transfer, password protection, and any notes provided by either workstation 208.

Preferably, when the receiving workstation 208 selects the hyperlink included in the invitation, an HTML interface is provided from information processor 202 and displayed on the receiving workstation 208. In a preferred embodiment, the HTML is served by script 205, in accordance with known programming techniques. The user of receiving workstation 208 is preferably prompted to submit information, such as a user name and/or password. The user of receiving workstation 208 preferably selects a control that requests script 205 to initiate the transfer between the sending workstation 208 and the receiving workstation 208.

Preferably, once script 205 has received a request to initiate the transfer, and the conditions for script 205 to initiate the transfer have been met (i.e., both the receiving workstation 208 and the sending workstation 208 have active communication sessions with information processor 202), the sending workstation 208 then authenticates the information and, based upon the authentication process, approves or disapproves the transfer. If approved, script 205 preferably operates to instruct the sending workstation 208 to compress and transmit the data file 106 over a secured session, such as HTTPS. As noted above, packets of the data file 106 are received by information processor 202, and the header information in the packets is modified to enable a forwarding of the packets to the receiving workstation 208.

Thus, in accordance with a preferred embodiment, the topology of the present invention enables a transmission of large data files and, accordingly, eliminates a need for a remote storage location, and enables the transfer when one or both of the sending device and receiving device install client software 207 thereon. By enabling the use of a third tier web server, as known in the art, a low level script is executed which enables information processor 202 to act as a conduit between the sending device and the receiving device. Information processor 202 enables a data file transfer to be completed securely and quickly between the sending workstation 208 and the receiving workstation 208, and one of the workstations requires only a network connection, preferably a TCP/IP connection as used by standard web browsing software.

Although the above discussion regarding the preferred embodiment includes the sending workstation 208 with software installed to enable the selection and transmission of a data file, the invention is not so limited. In an alternative embodiment, the receiving workstation 208 can operate to have software installed and the sending workstation 208 can operate with only a network connection, such as provided by standard web browsing software. In this alternative embodiment, the receiving workstation 208 preferably identifies a data directory (or data folder) for receiving a data file 106.

Continuing with reference to the alternative embodiment, information processor 202 preferably is operable as a web server and executes script 205 The receiving workstation 208 preferably identifies a directory on the receiving workstation 208 where file(s) 106 to be transmitted from the sending workstation 208 will be stored. The receiving workstation 208, in this embodiment, transmits an invitation including a hyperlink to the sending workstation 208, for example, via instant message or e-mail. The hyperlink preferably enables the sending workstation 208 to establish a connection to information processor 202 and further enables the sending workstation 208 to submit encrypted POST method values. These values preferably contain information to complete the transmission, such as the folder name or path on the receiving workstation 208, sending workstation 208 identifier, an amount of time defined for enabling the transfer, user authentication information, and any notes provided by either workstation 208.

Continuing with this alternative embodiment, when the user of the sending workstation 208 selects the hyperlink, he is preferably presented with a HTML web interface, preferably served by script 205. The user of the sending workstation 208 preferably selects the file he wishes to transmit to the receiving workstation 208. The user is also preferably prompted to submit information, such as a user name and password to authenticate the user of the receiving workstation. When script 205 receives the information, and conditions for the transfer are met (e.g., both the sending workstation and the receiving workstation 208 have an active communication session with information processor 202), the user of the sending workstation 208 preferably selects a control (e.g., a button) that requests script 205 to initiate the transfer.

Once the request to initiate the transfer is received, script 205 preferably causes packets of the data file 106 to be transmitted from the sending workstation 208 to information processor 202, for example, via HTTP. As described above, information processor 202 preferably modifies header information in the packets to represent the receiving workstation 208. The packets are preferably forwarded to the receiving workstation 208 and saved in the respective data folder previously identified by the receiving workstation 208. Thus, after preparations are completed, the sending workstation 208 transfers packets of the data file(s) to information processor 202, preferably via a direct TCP/IP transfer, and information processor 202 preferably forwards the packets to the receiving workstation 208.

Thus, in accordance with this alternative embodiment, a data file transfer can occur in accordance with the teachings herein, and further wherein the sending workstation 208 has an active TCP/IP connection, preferably via a standard web browsing software application. In this way, only the receiving workstation 208 operates additional software to facilitate a request for a data file transfer and, unlike the prior art, the sending workstation 208 requires no additional software to be installed.

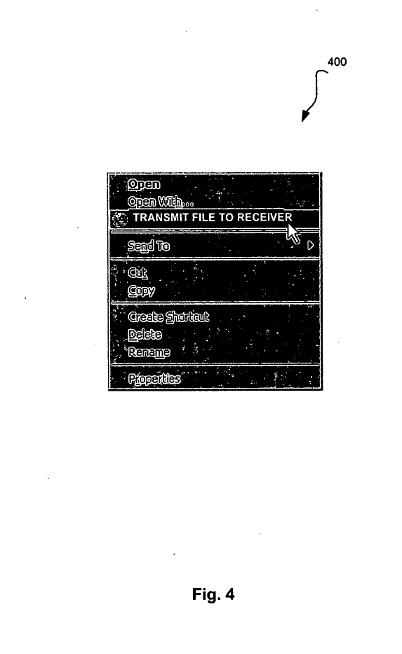

FIGS. 4-9 illustrate example display screens provided in accordance with a user of a sending workstation 208 who is transferring a data file to a user of a receiving workstation 208. In the embodiment shown in FIGS. 4-9, the sending workstation 208 has the client software 207 installed thereon.

FIG. 4 is a portion of example display screen that illustrates pop-up menu 400 that enables a user to select a particular data file to transmit to a receiving workstation 208, in accordance with the teachings herein. Preferably, pop-up menu 400 is displayed when a user identifies a particular file and/or directory by selecting a particular keystroke or clicks a selection device (e.g., “right-mouseclicks” over a file name). To select the particular file/directory for transmission, the user selects a choice to transmit the file to a receiver, and the file is identified for transmission.

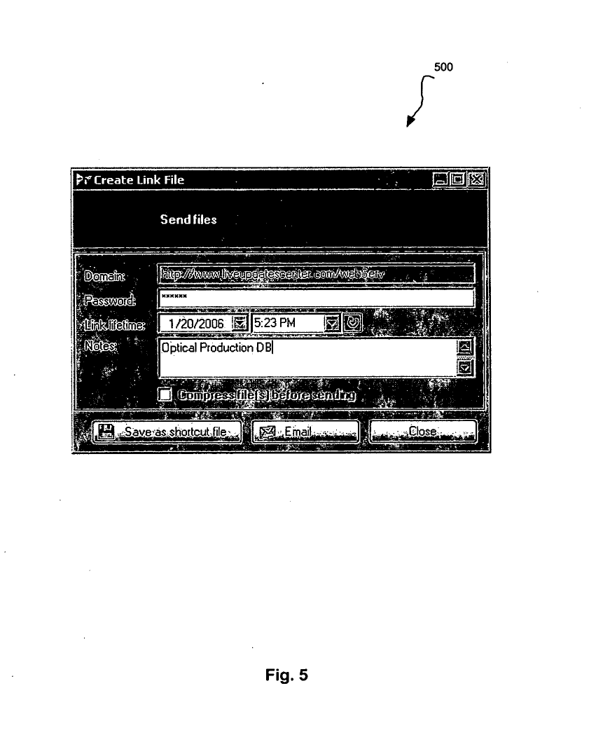

FIG. 5 is an example display screen 500 that enables a user of a sending workstation 208 to create a hyperlink to be used in a notification (referred to herein as an invitation) to a receiving workstation 208, and to identify parameters for information processor 202 to use for the transfer process. In the example display screen 500, the user identifies the domain which represents the web site provided by information processor 202, identifies a password to enable the transfer, identifies end date after which the data transfer should not occur, selects whether the data should be compressed, whether a shortcut file should be generated, and a command to e-mail the notification to the receiving workstation 208.

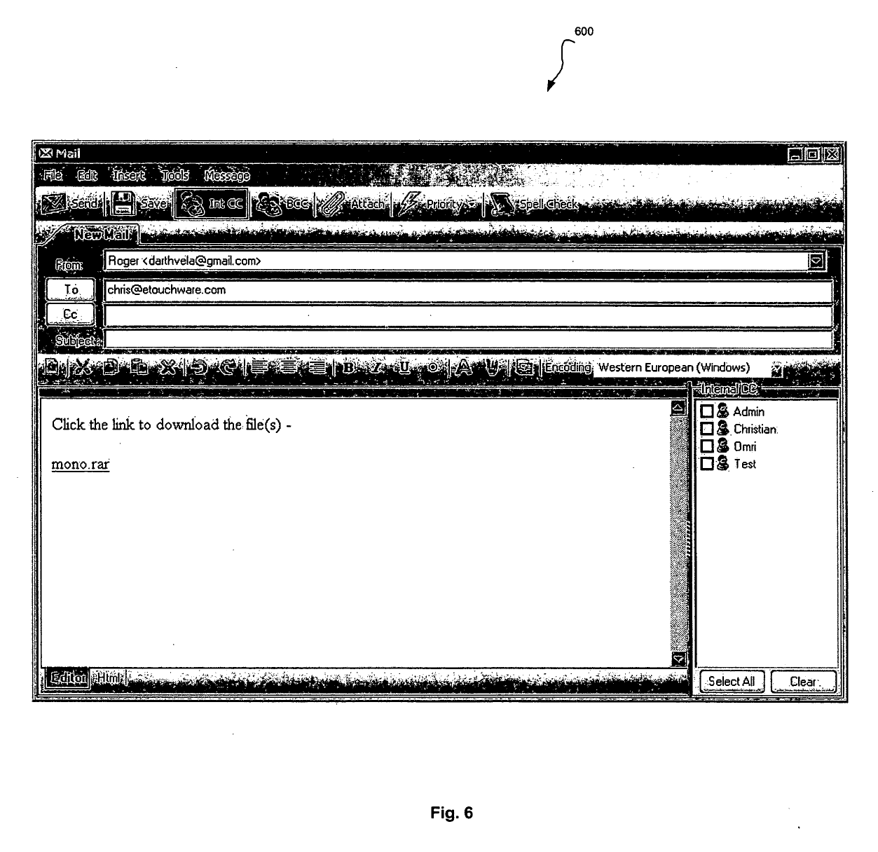

FIG. 6 illustrates an example display screen 600 that preferably appears when a user selects a control to e-mail the notification, substantially as illustrated in FIG. 5. In accordance with a preferred embodiment, when the user selects the control to e-mail the notification, the e-mail client software installed on the sending workstation 208 is preferably invoked and a message is preferably pre-formatted that identifies the hyperlink to be included in the e-mail notification to the receiving workstation 208. In the example shown in FIG. 6, the hyperlink is named “mono.rar.”

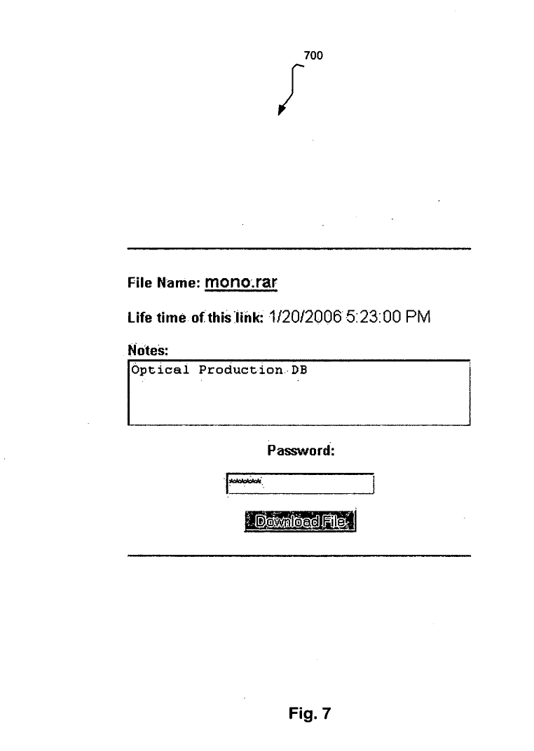

FIG. 7 is an example display screen 700 that illustrates an example invitation received by a receiving workstation 208. Included in the example display screen 700 is the name of the file to be downloaded, the ending date for receiving the file, some notes representing the file and provided by the user of the sending workstation 208, a password text control box for enabling the user of the receiving workstation 208 to submit a password, and a download file button to instruct script 205 to initiate the file transfer process from the sending workstation 208 and, ultimately, to the receiving workstation 208. Although in the embodiment shown in FIG. 7 includes a password text control box, such feature is not required. For example, in case the user of the receiving workstation is already authenticated, or in case no password is required, then password text box may not be included.

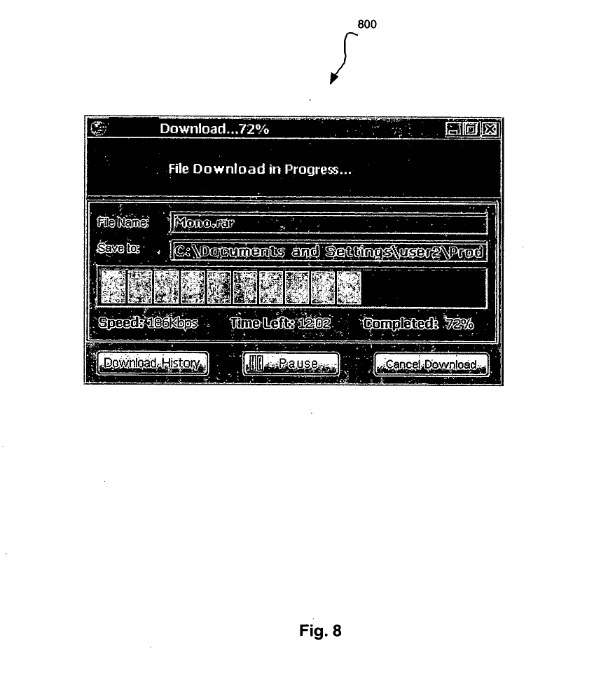

FIG. 8 is an example display screen 800 that preferably includes a progress bar indicating the completion percentage of a download process. In addition to indicated the progress of a download process, display screen 800 includes graphic screen controls to enable a user to pause the download process, to review a history of previous download processes, and to cancel the download process.

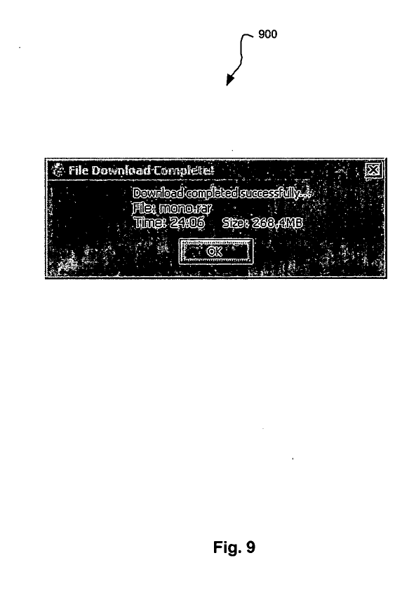

FIG. 9 is an example display screen 900 that is provided upon successful completion of a file transfer from a sending workstation 208 to a receiving workstation 208. In the example shown in FIG. 9, the file was transferred in 24.06, and the file was 268.4 megabytes. One skilled in the art will recognize that a 268.4 megabyte file is a large file for transferring over a network, and that, according to current standards, 24 minutes is a very short amount of time for such a large file.

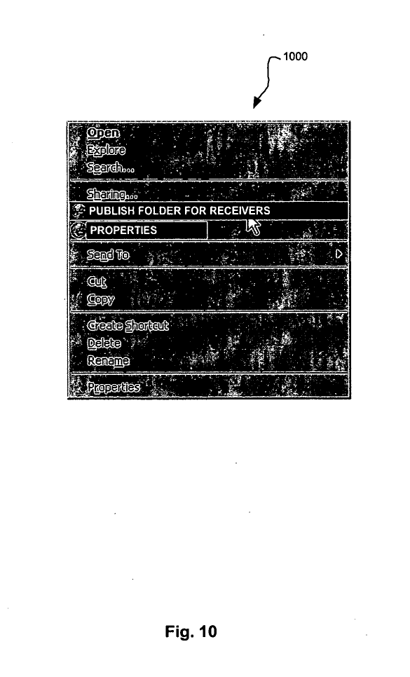

FIGS. 10-16 illustrate example display screens provided in accordance with a user of a receiving workstation 208 who is desiring to receive a data file from a user of a sending workstation 208. In the embodiment shown in FIGS. 10-16, the receiving workstation 208 has the client software 207 installed thereon.

FIG. 10 illustrates a portion of example display screen that illustrates pop-up menu 1000 that enables a user of a receiving workstation 208 to request that one or more data files stored on a sending workstation 208 be transmitted to a particular data directory (or folder) on the receiving workstation 208. In the embodiment shown in FIG. 10, the data directory (or folder) is “published” to a sending workstation 208, information processor 202 or both. Preferably, pop-up menu 1000 is displayed when a user selects a particular keystroke or clicks a selection device (e.g., “right-mouseclicks”). To identify the particular directory where a file should be transmitted, the user selects a choice to publish the folder for receivers.

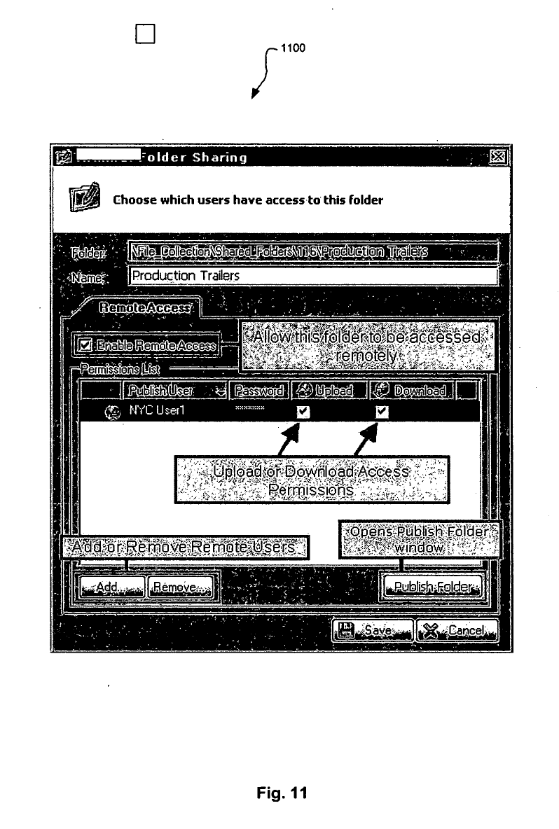

FIG. 11 illustrates an example folder sharing selection display screen 1100 that is provided for a user of a receiving workstation 208 to identify a folder on the receiving workstation 208 for receiving a transmitted data file 106. As shown in FIG. 11, the user of a receiving workstation 208 identifies a folder, submits a name, and identifies a list of users (illustrated as NYC User1) to have permission to transmit a file to the identified folder. Once selected, the user of the receiving workstation 208 preferably selects a graphical screen control (i.e., a button) labeled publish folder in order to identify the folder in an invitation to a user of the sending workstation 208 and request that uploaded data file(s) from the sending workstation 208 be transmitted to the identified “published” folder in FIG. 11.

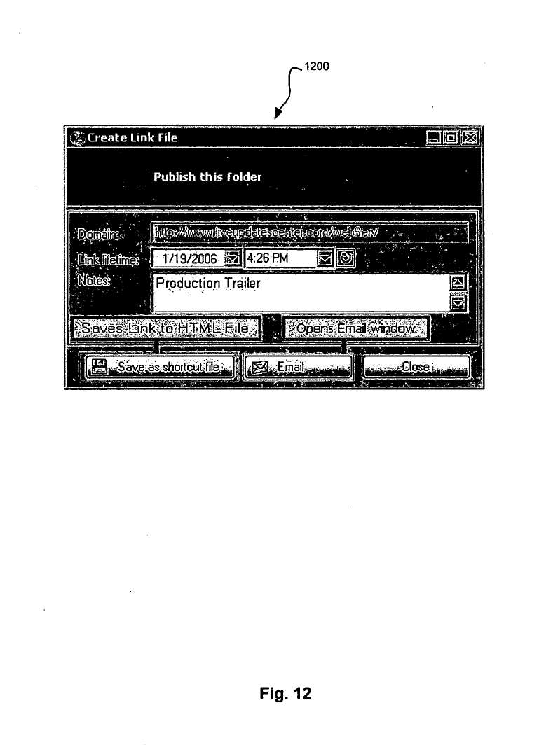

FIG. 12 is an example display screen 1200 that enables a user of a receiving workstation 208 to create a hyperlink to be used in an invitation for a sending workstation 208. The example display screen 1200 further enables the user to identify parameters for information processor 202 to use for the transfer process. In the example display screen 1200, the user identifies the domain which represents the web site provided by information processor 202, identifies an end date after which the data transfer should not occur, selects whether a shortcut file should be generated, and a selects command to e-mail the notification to the sending workstation 208.

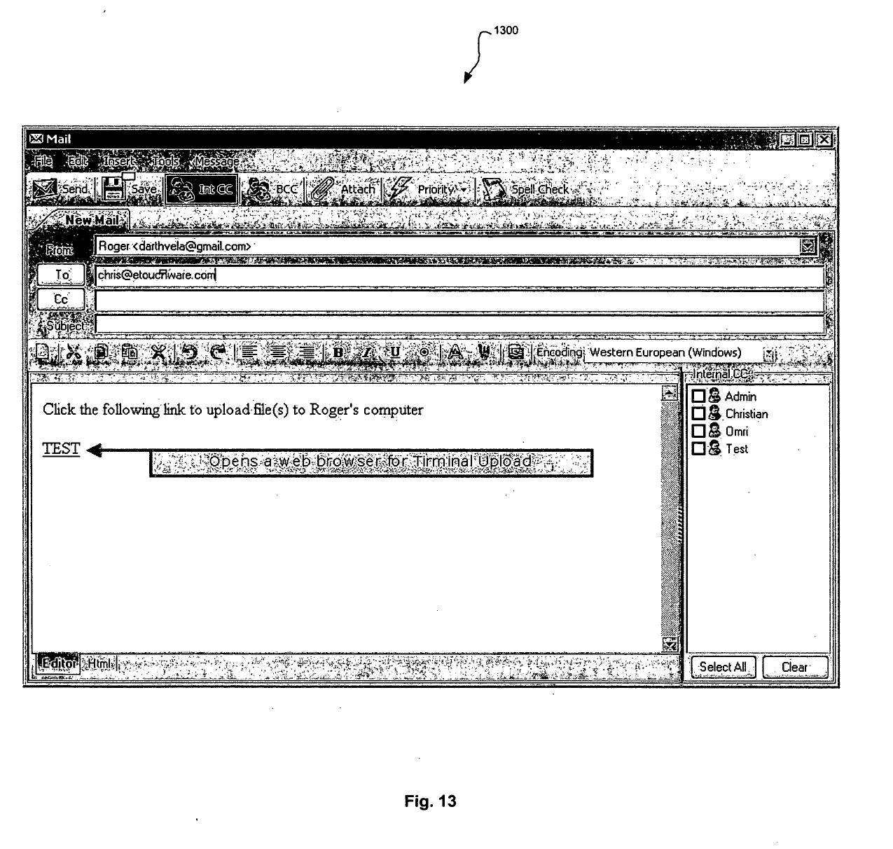

FIG. 13 illustrates an example display screen 1300 that preferably appears when a user selects a control to e-mail the notification, substantially as illustrated in FIG. 12. In accordance with a preferred embodiment, when the user selects the control to e-mail the notification, the e-mail client software installed on the sending workstation 208 is preferably invoked and a message is preferably pre-formatted that identifies the hyperlink to be included in the e-mail notification to the receiving workstation 208. In the example shown in FIG. 13, the hyperlink is named “TEST.”

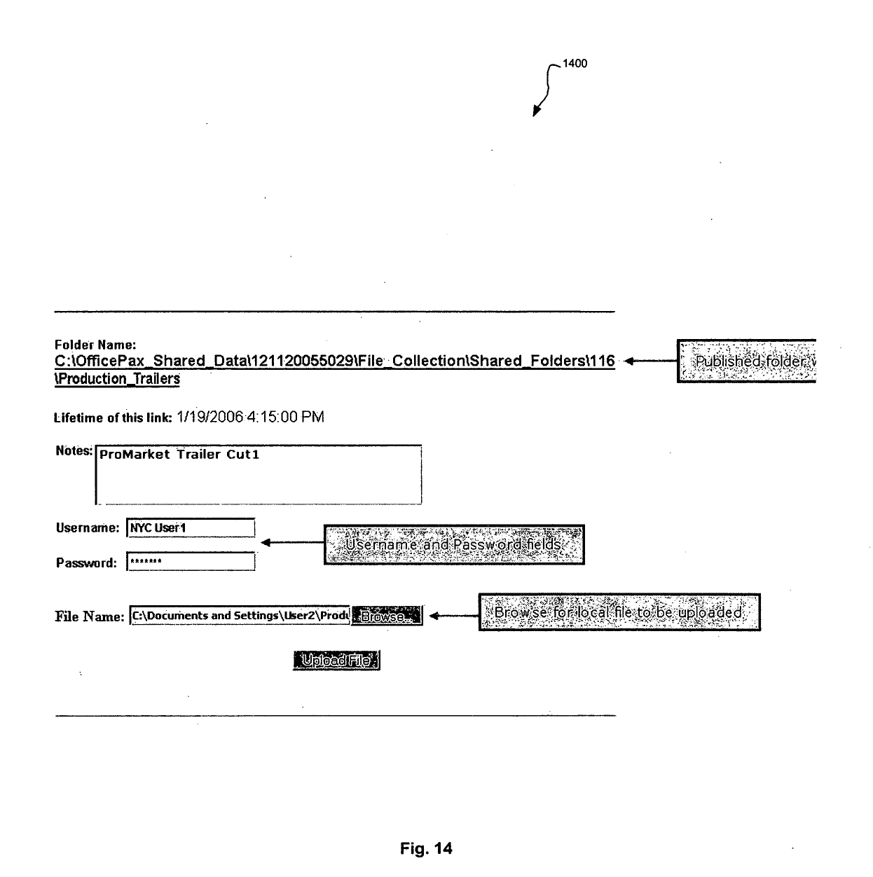

FIG. 14 is an example display screen 1400 that is displayed on a sending workstation 208 in response to selecting the hyperlink shown in FIG. 13. Included in the example display screen 1400 is the name of the shared folder where the data file is to be transmitted on the receiving workstation 208, the ending date for receiving the file, some notes representing the file and provided by the user of the receiving workstation 208, a password text control box for enabling the user of the receiving workstation 208 to access the folder, and a browse button that enables a particular file accessible by the sending workstation 208 to be located, selected and transmitted to the receiving workstation 208. After a respective file is selected, the user of the sending workstation 208 preferably selects a control labeled UPLOAD FILE and the file is preferably transmitted from the sending workstation 208 to the information processor 202, and thereafter to the receiving workstation 208, substantially as described above.

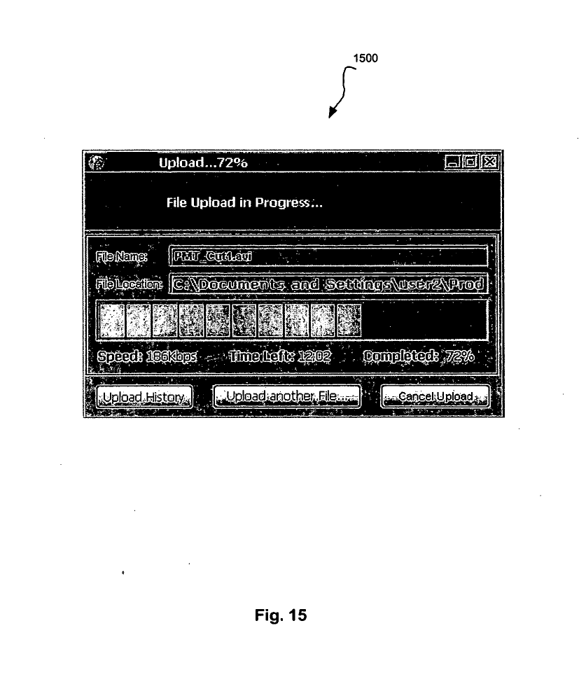

FIG. 15 is an example display screen 1500 that preferably includes a progress bar indicating the completion percentage of an upload process. In addition to indicated the progress of an upload process, display screen 1500 includes graphic screen controls to enable a user to upload another file, to review a history of previous upload processes, and to cancel the upload process.

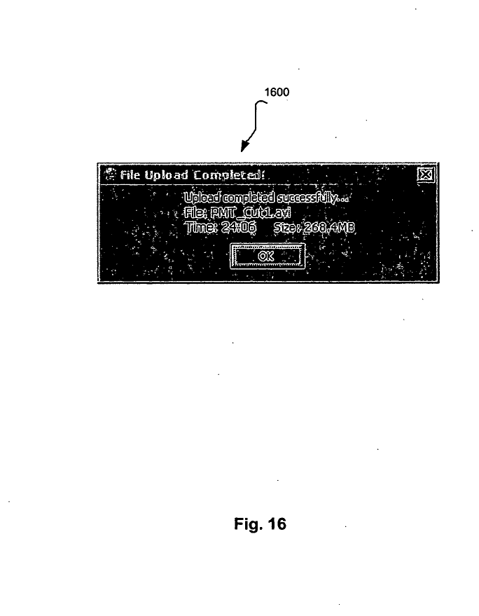

FIG. 16 is an example display screen 1600 that is provided upon successful completion of a file upload from a sending workstation 208 to a receiving workstation 208. In the example shown in FIG. 16, the file was transferred in 24.06 minutes, and the file was 268.4 megabytes. One skilled in the art will recognize that a 268.4 megabyte file is a large file for transferring over a network, and that, according to current standards, 24 minutes is a very short amount of time for such a large file.

Thus, the present invention includes a protocol that enables users to transfer sensitive material in large-sized files (e.g., hundreds of megabytes) securely and easily. The invention enables the transfer without requiring both the sender and receiver to install and configure special software The invention further provides for data encryption and compression, thereby enabling data transfers at great speeds with security.

The invention comprises a system and method for facilitating a transfer of a data file over a communication network. In one embodiment, a sending workstation 208 having a data file 106 stored thereon identifies the receiving workstation 208 for the data file, and transmits to the second workstation 208 an invitation to receive the data file. The invitation includes at least an identifier or the IP address of the first workstation 208. The second workstation 208 uses the invitation to communicate to information processor 202 via HTTP, which inherently includes the IP address of the receiving workstation 208. In a preferred embodiment, the user of the receiving workstation 208 submits a user name and password to information processor 202 to establish that the user is authorized to receive the data file. The HTTP session between the receiving workstation 208 and information processor 202 is preferably maintained until the receiving workstation 208 has fully received the data file 106.

Prior to transmitting the data file 106, the sending workstation 208 preferably maintains an active connection to a communication network 206, such as the internet, and operates software 207 to recognize when information processor 202 attempts to communicate with the sending workstation 208. In other words, the sending workstation 208 operates software 207 that “listens,” for example, on a predefined port for information processor 202. Information processor 202 contacts the sending workstation 208, the sending workstation 208 replies and an active data communication session is maintained between the first workstation and the information processor while the HTTP session is active between the receiving workstation 208 and the information processor 202.

While information processor 202 has an active communication session with the sending workstation 208 and the receiving workstation 208, the software operating on the sending workstation 208 preferably compresses the data file 106, and thereafter transmits encrypted packets of the data file 106 to information processor 202. In one embodiment, information processor 202 and the receiving workstation 208 maintain a secure HTTP (“HTTPS”) session, thereby effecting the security (e.g., encryption) of the file. Information processor 202 subsequently forwards the data file, preferably via HTTP, by modifying the header information of the packets of the data file 106 to represent the receiving workstation 208. Thus, the present invention preferably enables a transfer of files, regardless of size, from without the need to store the complete files on a remote storage location.

In an alternative embodiment of the present invention, only the receiving workstation 208 has the client program 207 installed thereon. In this embodiment, the receiving workstation 208 uses the client program 207 to identify a data path (or data folder) to receive a data file 106, and an invitation to receive a data file 106 is transmitted from the receiving workstation 208 to a sending workstation 208. The invitation is used by the sending workstation 208 to establish a session, preferably HTTP, with the information processor 202. A web form is preferably provided by the information processor 202 to the sending workstation 208 and used to identify a data file 106, such as by navigating data folders and files, that is available to the sending workstation 208. The sending workstation 208 uploads packets of the data file 106 to information processor 202, preferably via HTTP, and the information processor 202 forwards the packets to the receiving workstation 208, preferably by modifying the header information in the packets.

The present invention is operable such that a data file transfer can occur when the sending workstation, the receiving workstation, or both workstations have the client software installed thereon.

Other features of the present invention are provided. For example, a database 204 may be provided on information processor 202 that stores an identifier (e.g., a sort of index value) representing the sending workstation 208 and further stores a corresponding IP address. The identifier is used by the information processor 202 to make reference to the sending workstation 208. In case the IP of the sending workstation 208 changes, such as resulting from a dynamically assigned IP address by a service provider, the database 204 is updated to reflect the new IP address. The invitation transmitted to the receiving workstation 208 preferably includes the identifier, and the identifier is preferably transmitted to information processor 202 by the receiving workstation 208, which represents the sending workstation 208. Information processor 202 uses the identifier to communicate with the sending workstation 208 and instruct it to transmit the data file 106.

In a preferred embodiment, various messages are transmitted to the workstations 208 to inform the users thereof of certain conditions. For example, in case the sending workstation 208 is not maintaining an active connection to the communication network (i.e., is off-line), or is otherwise not communicating with information processor 202, then information processor 202 alerts the receiving workstation 208 that the transfer will not take place at that time. Alternatively, in case the user of the receiving workstation 208 submits a password that is rejected by the sending workstation 208, a message is transmitted to the user of the receiving workstation 208 that an incorrect password was submitted. The messages may be formatted in various ways, such as in web pages, instant mail messages, or e-mail messages.

In yet another embodiment, at least one of the workstations 208 can operate as a web server, thereby eliminating a requirement for information processor 202 to operate as a third tier server. In this alternative embodiment, workstation 208 is configured, for example, via client software 207 to operate as a web server and, accordingly, to perform many if not all of the functions described herein with regard to information processor 202.

Other uses and products provided by the present invention will be apparent to those skilled in the art. Although the present invention has been described in relation to particular embodiments thereof, many other variations and modifications and other uses will become apparent to those skilled in the art. It is preferred, therefore, that the present invention not be limited by the specific disclosure herein, but to be afforded the full scope afforded by the appended claims.

1. A system for facilitating a transfer of a data file over a communication network, the system comprising:
a first workstation having a data file stored thereon, wherein the first workstation is operable to communicate on the communication network, to identify the data file to be transmitted over the communication network, to identify a receiver of the data file, and to transmit to the identified receiver an invitation to receive the data file;
a second workstation operable to communicate on the communication network, wherein the second workstation is identified by the first workstation as the receiver of the data file, and further wherein the second workstation is operable to receive the invitation from the first workstation;
a web server operable to communicate on the communication network, and further operable to receive from the second workstation an identifier of the first workstation as a function of the second workstation responding to the invitation;
wherein the web server receives from the first workstation packets of the data file, and forwards the packets to the second workstation.

2. The system of claim 1, wherein the invitation includes a hyperlink to the web server.

3. The system of claim 2, wherein the web server provides a data entry form to the second workstation as a function of the hyperlink.

4. The system of claim 1, wherein the web server simultaneously maintains a first communication session with the first workstation and a second communication session with the second workstation during the transfer.

5. The system of claim 1, wherein the second workstation communicates on the network using TCP/IP and with a web browser.

6. The system of claim 1, wherein the web server uses the invitation received from the second workstation to display a data entry form for the second workstation to submit a password.

7. The system of claim 1, wherein the first workstation has software installed thereon that enables the identification of the data file, the generation of the invitation, and the transmission of the packets of the data file to the web server.

8. The system of claim 7, wherein the second workstation does not have the software installed thereon.

9. The system of claim 1, wherein the first workstation further compresses the data file prior to transmitting the packets of the data file to the web server.

10. A system for facilitating a transfer of a data file over a communication network, the system comprising:
a first workstation having a data file stored thereon, wherein the first workstation is operable to communicate on the communication network;
a second workstation operable to communicate on the communication network, wherein the second workstation identifies a directory for receiving the data file, and further generates and transmits to the first workstation an invitation that includes at least a name of the directory to identify where the data file is to be transmitted on the second workstation;
a web server operable to communicate on the communication network, and is further operable to receive from the first workstation an identifier of the second workstation as a function of the first workstation responding to the invitation;
wherein the web server receives from the first workstation packets of the data file, and forwards the packets to the second workstation.

11. The system of claim 10, wherein the invitation includes a hyperlink to the web server.

12. The system of claim 11, wherein the web server provides a data entry form to the first workstation as a function of the hyperlink.

13. The system of claim 12, wherein the web server simultaneously maintains a first communication session with the first workstation and a second communication session with the second workstation during the transfer.

14. The system of claim 10, wherein the web server further receives a communication port of the second workstation, and the web server communicates with the second workstation over the communication port.

15. The system of claim 10, wherein the first workstation communicates on the network using TCP/IP and with a web browser.

16. The system of claim 10, wherein the web server uses the invitation received from the first workstation to display a data entry form for the first workstation to select the data file.

17. The system of claim 10, wherein the second workstation has software installed thereon that enables the identification of the directory, the generation of the invitation, and the transmission of the packets of the data file to the web server.

18. The system of claim 17, wherein the first workstation does not have the software installed thereon.

19. The system of claim 10, wherein the first workstation further performs at least one of compressing and encrypting the data file prior to transmitting the packets of the data file to the web server.

20. The system of claim 1, wherein the web server transmits a message to one of the first or second workstation that the other of the first or second workstation is not operable to transmit or receive the data file.

21. The system of claim 10, wherein the web server transmits a message to one of the first or second workstation that the other of the first or second workstation is not operable to transmit or receive the data file.

22. The system of claim 1, further comprising a database maintained by the web server that includes an identifier of the first or second workstation and a corresponding IP address thereof.

23. The system of claim 10, further comprising a database maintained by the web server that includes an identifier of the first or second workstation and a corresponding IP address thereof.

24. A method for facilitating a transfer of a data file over a communication network, the method comprising:
storing a data file on a first workstation, and providing the first workstation with software enabling the first workstation to:
communicate on the communication network;
identify the data file to be transmitted over the communication network;
identify a receiver of the data file; and
transmit to the identified receiver an invitation to receive the data file;
providing a second workstation with software enabling the second workstation to communicate on the communication network, wherein the second workstation is identified by the first workstation to be the receiver of the data file, and further wherein the second workstation is operable to receive the invitation from the first workstation;
providing a web server that is operable to communicate on the communication network, wherein the web server is operable to receive from the second workstation an identifier of the second workstation as a function of the second workstation responding to the invitation;
receiving by the web server from the first workstation packets of the data file, and forwarding by the web server the packets to the second workstation.

25. The method of claim 21, further comprising formatting the invitation with a hyperlink to the web server.

26. The method of claim 25, further comprising providing a data entry form by the web server to the second workstation as a function of the hyperlink.

27. The method of 24, further comprising receiving by the web server a communication port of the second workstation, and transmitting the communication port by the web server to the first workstation.

28. The method of claim 24, wherein the second workstation communicates on the network using TCP/IP and with a web browser.

29. The method of claim 24, further comprising using by the web server the invitation received from the second workstation to display a data entry form for the second workstation to submit a password.

30. The method of claim 24, wherein the first workstation has software installed thereon that enables the identification of the data file, the generation of the invitation, and the transmission of the packets of the data file to the web server.

31. The method of claim 30, wherein the second workstation does not have the software installed thereon.

32. The method of claim 24, further comprising at least one of compressing and encrypting the data file by the first workstation prior to transmitting the packets of the data file to the second workstation.

33. The system of claim 1, wherein the web server is installed on one or more of an information processor, the first workstation and the second workstation.

34. The system of claim 10, wherein the web server is installed on one or more of an information processor, the first workstation and the second workstation.

35. The method of claim 24, wherein the web server is installed on one or more of an information processor, the first workstation and the second workstation.
